(19) United States
(12) Patent Application Publication
(10) Pub. No.: US 2016/0034131 A1
(43) Pub. Date: Feb. 4, 2016

(54) METHODS AND SYSTEMS OF A GRAPHICAL USER INTERFACE SHIFT

(71) Applicant: Sony Corporation, Tokyo (JP)

(72) Inventor: Junichi KOSAKA, Tokyo (JP)

(73) Assignee: Sony Corporation, Tokyo (JP)

(21) Appl. No.: 14/447,768

(22) Filed: Jul. 31, 2014

(51) Int. Cl. G06F 3/0488; G06F 3/044; G06F 3/0484

(52) U.S. Cl. CPC G06F 3/0488; G06F 3/04842; G06F 3/044

(57) ABSTRACT

Embodiments include an electronic device that has a display configured to display a graphical user interface (GUI) for a user to control aspects of the electronic device, and a touch panel superimposed on or integrated with the display. The electronic device also has circuitry that is configured to initiate a process to shift the GUI on the display upon determining that an area of a touch input exceeds a predetermined area or a continuous duration of the touch input exceeds a predetermined period of time or an applied pressure of the touch input exceeds a predetermined pressure during movement of the area of the touch input.

### BACKGROUND OF THE INVENTION

1. Field of the Invention

Systems and methods for shifting a graphical user interface (GUI) of an electronic device are described. In particular, custom adjusted GUI systems and methods are described.

2. Description of the Related Art

Electronic devices such as smartphones and tablet devices may include a touch panel screen such that a user may perform touch operations on a displayed interface. For example, the user may touch the operating surface of the touch panel screen with his/her finger or a pen to perform an input operation. A small screen size allows a user to reach any part of the screen with just a thumb of the hand that is holding the device.

In recent years, in an effort to provide more information to the user, display screens in electronic devices have grown larger in size. Many smartphones will have a diagonal screen length of six inches or more. However, the increasing screen size causes difficulty when a user wishes to perform a touch operation using a single hand (i.e., the hand holding the electronic device). In particular, a touch operation using a thumb on a single hand that is holding the electronic device becomes difficult because the user's thumb cannot reach all areas of the touch panel display surface. For example, a user holding a bottom right corner of the electronic device cannot reach the upper left corner of the device with the right thumb in order to perform a touch operation. Likewise, a user holding a bottom left corner of the electronic device cannot reach the upper right corner of the device with the left thumb in order to perform a touch operation. As a result, users are precluded from performing single-handed touch operations on electronic devices with large touch panel display screens, thereby requiring the user to operate the touch panel device using both hands and/or requiring the user to place the electronic device on a resting surface such as a table while performing the touch operation.

### SUMMARY OF THE INVENTION

Embodiments include an electronic device that has a display containing a graphical user interface for a user to control aspects of the electronic device, and a touch panel superimposed on or integrated with the display and containing a physical touch panel display screen. The electronic device also has a controller to control each element in the electronic device. A screen image of the display is shifted a proportional distance according to a movement of a touched area received in the touch panel, by means of a processor of the controller.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a non-limiting example of a block diagram of an electronic device, according to one embodiment;

FIG. 2 illustrates the electronic device held with a single hand, according to one embodiment;

FIG. 3A illustrates the multiple modes of a screen image shifting process, according to one embodiment;

FIG. 3B is a flowchart for a screen image shifting process, according to one embodiment;

FIG. 4A is a flowchart for a “shift” screen mode, according to one embodiment;

FIG. 4B is a flowchart for an “adjust” screen mode, according to one embodiment;

FIG. 5 is an illustration of a displaced screen image, according to one embodiment;

FIGS. 6A-6B illustrate touch areas received on a screen, according to one embodiment;

FIG. 7 is a graph illustrating a touch area to a ratio of touch lengths, according to one embodiment;

FIG. 8 is a graph illustrating a touch area to a moving coefficient, according to one embodiment;

FIGS. 9A-9B are illustrations of a touch area and a screen display movement, according to one embodiment;

FIGS. 10A-10B illustrate moving directions of a screen image, according to one embodiment;

FIG. 11 illustrates shifting a specific layer of icons, according to one embodiment; and

FIG. 12 illustrates shifting a pop-up window, according to one embodiment.

Referring now to the drawings, wherein like reference numerals designate identical or corresponding parts throughout the several views.

### DETAILED DESCRIPTION OF THE PREFERRED EMBODIMENTS

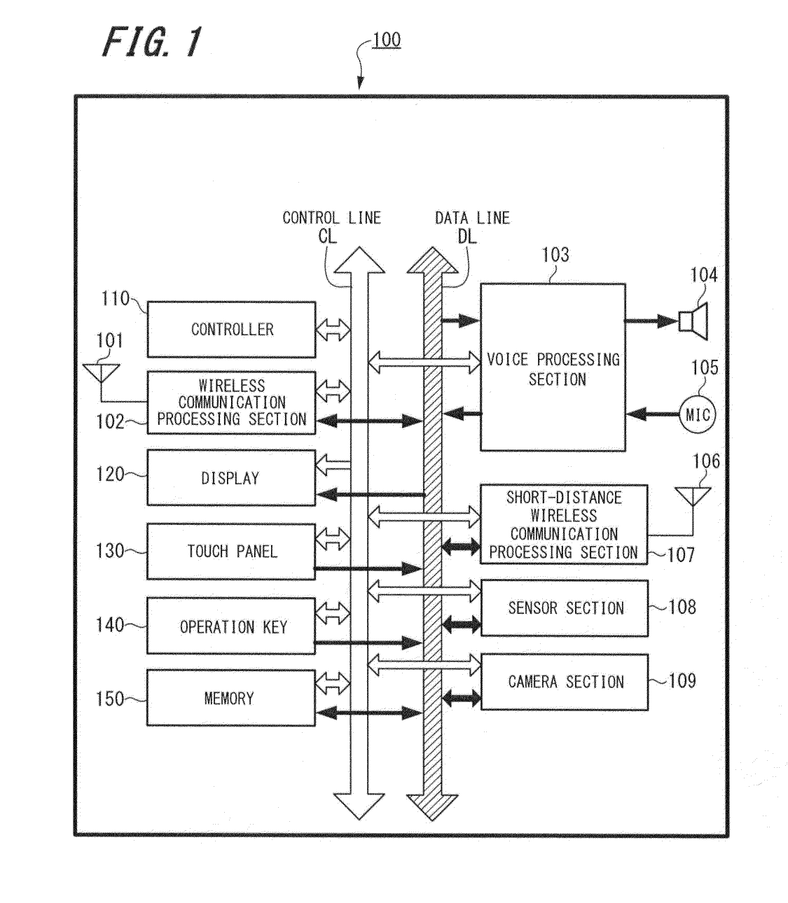

FIG. 1 illustrates a block diagram for an exemplary electronic device according to certain embodiments of the present disclosure. In certain embodiments, electronic device 100 may be a smartphone. However, the skilled artisan will appreciate that the features described herein may be adapted to be implemented on other devices (e.g., a laptop, a tablet, a server, an e-reader, a camera, a navigation device, etc.). The exemplary electronic device 100 of FIG. 1 includes a controller 110, a wireless communication processor 102 connected to an antenna 101, a speaker 104, a microphone 105, and a voice processor 103.

The controller 110 may include one or more Central Processing Units (CPUs), and may control each element in the electronic device 100 to perform functions related to communication control, audio signal processing, control for the audio signal processing, still and moving image processing and control, and other kinds of signal processing. The controller 110 may perform these functions by executing instructions stored in a memory 150. Alternatively or in addition to the local storage of the memory 150, the functions may be executed using instructions stored on an external device accessed on a network, or on a non-transitory computer readable medium.

The memory 150 may include, e.g., Read Only Memory (ROM), Random Access Memory (RAM), or a memory array including a combination of volatile and non-volatile memory units. The memory 150 may be utilized as working memory by the controller 110 while executing the processes and algorithms of the present disclosure. Additionally, the memory 150 may be used for long-term storage, e.g., of image data and information related thereto.

The electronic device 100 includes a control line CL and data line DL as internal communication bus lines. Control data to/from the controller 110 may be transmitted through the control line CL. The data line DL may be used for transmission of voice data, display data, etc.

The antenna 101 transmits/receives electromagnetic wave signals between base stations for performing radio-based communication, such as the various forms of cellular telephone communication. The wireless communication processor 102 controls the communication performed between the electronic device 100 and other external devices via the antenna 101. For example, the wireless communication processor 102 may control communication between base stations for cellular phone communication.

The speaker 104 emits an audio signal corresponding to audio data supplied from the voice processor 103. The microphone 105 detects surrounding audio, and converts the detected audio into an audio signal. The audio signal may then be output to the voice processor 103 for further processing. The voice processor 103 demodulates and/or decodes the audio data read from the memory 150, or audio data received by the wireless communication processor 102 and/or a short-distance wireless communication processor 107. Additionally, the voice processor 103 may decode audio signals obtained by the microphone 105.

The exemplary electronic device of FIG. 1 may also include a display 120, a touch panel 130, an operation key 140, and a short-distance communication processor 107 connected to an antenna 106. The display 120 may be a Liquid Crystal Display (LCD), an organic electroluminescence display panel, or another display screen technology. In addition to displaying still and moving image data, the display 120 may display operational inputs, such as numbers or icons, which may be used for control of the electronic device 100. The display 120 may additionally display a GUI such that a user may control aspects of the electronic device 100 and/or other devices. Further, the display 120 may display characters and images received by the electronic device 100 and/or stored in the memory 150 or accessed from an external device on a network. For example, the electronic device 100 may access a network such as the Internet, and display text and/or images transmitted from a Web server.

The touch panel 130 may include a physical touch panel display screen and a touch panel driver. The touch panel 130 may include one or more touch sensors for detecting an input operation on an operation surface of the touch panel display screen. The touch panel 130 also detects a touch shape and a touch area. Used herein, the phrase “touch operation” refers to an input operation performed by touching an operation surface of the touch panel display with an instruction object, such as a finger, thumb, or stylus-type instrument. In the case where a stylus, or the like, is used in a touch operation, the stylus may include a conductive material at least at the tip of the stylus such that the sensors included in the touch panel 130 may detect when the stylus approaches/contacts the operation surface of the touch panel display (similar to the case in which a finger is used for the touch operation).

In certain aspects of the present disclosure, the touch panel 130 may be disposed adjacent to the display 120 (e.g., laminated), or may be formed integrally with the display 120. For simplicity, the present disclosure assumes the touch panel 130 is formed integrally with the display 120 and therefore, examples discussed herein may describe touch operations being performed on the surface of the display 120 rather than the touch panel 130. However, the skilled artisan will appreciate that this is not limiting.

For simplicity, the present disclosure assumes the touch panel 130 is a capacitance-type touch panel technology; however, it should be appreciated that aspects of the present disclosure may easily be applied to other touch panel types (e.g., resistance type touch panels) with alternate structures. In certain aspects of the present disclosure, the touch panel 130 may include transparent electrode touch sensors arranged in the X-Y direction on the surface of transparent sensor glass.

The touch panel driver may be included in the touch panel 130 for control processing related to the touch panel 130, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger, is within a predetermined distance from an operation surface of the touch panel display screen. That is, the instruction object does not necessarily need to directly contact the operation surface of the touch panel display screen for touch sensors to detect the instruction object and perform processing described herein. For example, in certain embodiments, the touch panel 130 may detect a position of a user's finger around an edge of the display panel 120 (e.g., gripping a protective case that surrounds the display/touch panel). Signals may be transmitted by the touch panel driver, e.g., in response to a detection of a touch operation, in response to a query from another element, based on timed data exchange, etc.

The touch panel 130 and the display 120 may be surrounded by a protective casing, which may also enclose the other elements included in the electronic device 100. In certain embodiments, a position of the user's fingers on the protective casing (but not directly on the surface of the display 120) may be detected by the touch panel 130 sensors. Accordingly, the controller 110 may perform display control processing described herein based on the detected position of the user's fingers gripping the casing. For example, an element in an interface may be moved to a new location within the interface (e.g., closer to one or more of the fingers) based on the detected finger position.

Further, in certain embodiments, the controller 110 may be configured to detect which hand is holding the electronic device 100, based on the detected finger position. For example, the touch panel 130 sensors may detect a plurality of fingers on the left side of the electronic device 100 (e.g., on an edge of the display 120 or on the protective casing), and detect a single finger on the right side of the electronic device 100. In this exemplary scenario, the controller 110 may determine that the user is holding the electronic device 100 with his/her right hand because the detected grip pattern corresponds to an expected pattern when the electronic device 100 is held only with the right hand.

The operation key 140 may include one or more buttons or similar external control elements, which may generate an operation signal based on a detected input by the user. In addition to outputs from the touch panel 130, these operation signals may be supplied to the controller 110 for performing related processing and control. In certain aspects of the present disclosure, the processing and/or functions associated with external buttons and the like may be performed by the controller 110 in response to an input operation on the touch panel 130 display screen rather than the external button, key, etc. In this way, external buttons on the electronic device 100 may be eliminated in lieu of performing inputs via touch operations, thereby improving water-tightness.

The antenna 106 may transmit/receive electromagnetic wave signals to/from other external apparatuses, and the short-distance wireless communication processor 107 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 107.

The electronic device 100 may include a motion sensor 108. The motion sensor 108 may detect features of motion (i.e., one or more movements) of the electronic device 100. For example, the motion sensor 108 may include an accelerometer, a gyroscope, a geomagnetic sensor, a geo-location sensor, etc., or a combination thereof, to detect motion of the electronic device 100. In certain embodiments, the motion sensor 108 may generate a detection signal that includes data representing the detected motion. For example, the motion sensor 108 may determine a number of distinct movements in a motion (e.g., from start of the series of movements to the stop, within a predetermined time interval, etc.), a number of physical shocks on the electronic device 100 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 110, whereby further processing may be performed based on data included in the detection signal.

The electronic device 100 may include a camera section 109, which includes a lens and shutter for capturing photographs of the surroundings around the electronic device 100. The images of the captured photographs can be displayed on the display panel 120. A memory section saves the captured photographs. The memory section may reside within the camera section 109, or it may be part of the memory 150.

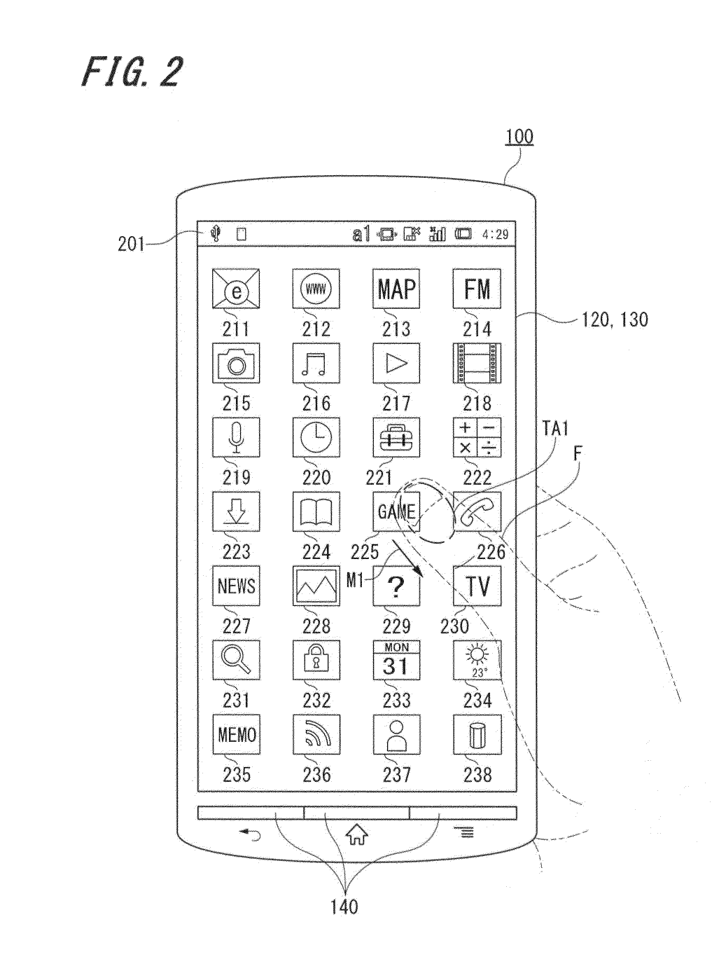

FIG. 2 illustrates the electronic device 100 held with a single hand. The electronic device 100 includes the display 120 and touch panel 130. Several icons 211-238 are arranged on the display 120. Each of the icons 211-238 functions as a button to start an associated application installed in the electronic device 100. For example, the controller 100 of FIG. 1 starts an application of an email program by touching the upper left icon 211 with a user's thumb F.

As illustrated in FIG. 2, the electronic device 100 is held with the user's right hand. Generally, when holding an electronic device such as a smartphone with a single hand, the user supports the underside of the electronic device with the fingers and/or palm, while performing touch operations with the user's thumb. In the example shown in FIG. 2, the user's thumb F is used to perform touch operations on the operating surface of the display 120. Because the user is holding and operating the electronic device 100 with a single hand, the operating range of the user's thumb F may be limited. Since the user's range of motion with the thumb F is limited, the user might be unable to perform a touch operation corresponding to the upper left icons 211, 212, 215, and 216 of FIG. 2. Likewise, a user holding the electronic device 100 with the left hand would have difficulty reaching the upper right icons with the left thumb. Therefore, in order to perform a touch operation by touching any of these four icons of a conventional display, the user would have to operate the electronic device touch panel display with two hands and/or place the electronic device 100 on a resting surface such as a table. However, embodiments described herein enable a user to reach even the distant icons of a display 120 with just the thumb F of the hand that is holding the electronic device 100.

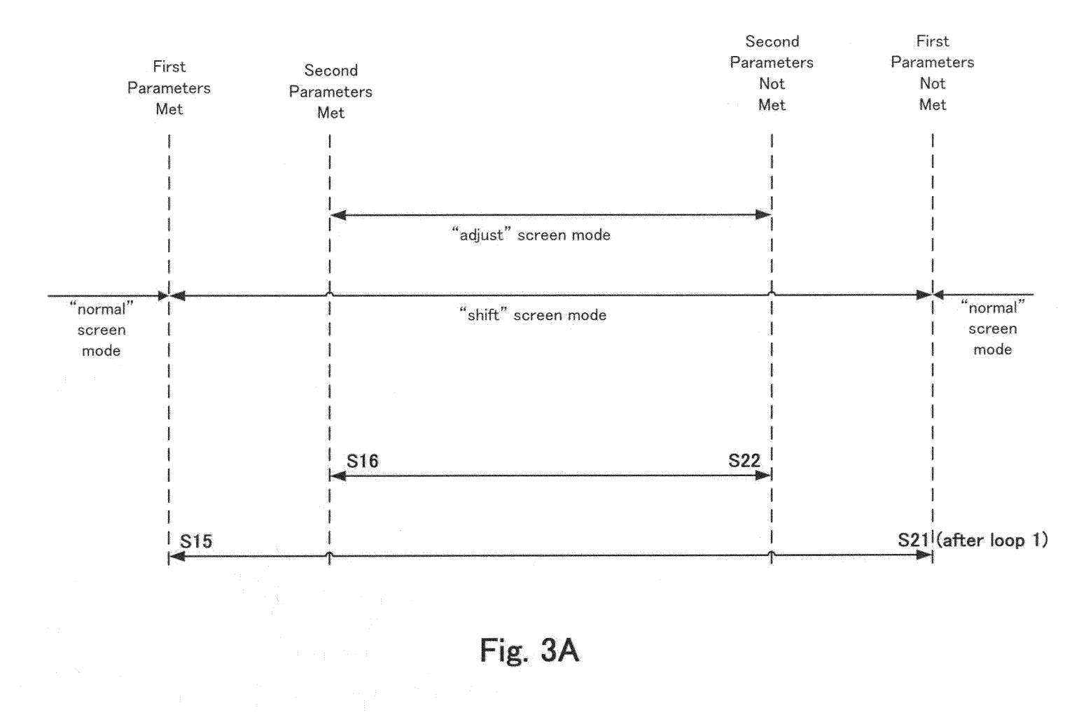

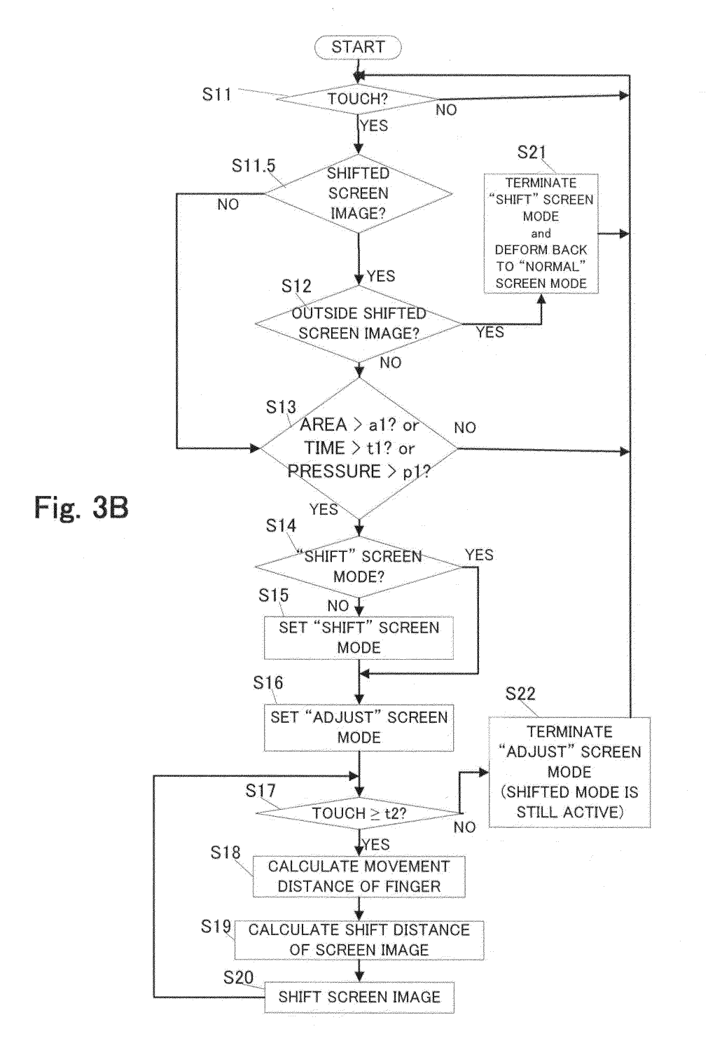

A screen image shifting process, which contains multiple screen modes, overcomes many of the disadvantages described above. For the sake of simplicity and ease of discussion, the following modes will be defined. However, other designations could be used to describe the same or similar functions. A “normal” screen mode exists when no movement or adjustment is made to the screen, such as the screen illustrated in FIG. 2. A “shift” screen mode is initiated upon a first set of parameters being met, which will be described later with reference to FIG. 3B. The “shift” screen mode puts the screen into a ready state for subsequent adjustment. An “adjust” screen mode moves the screen, entirely or in part, based upon a second set of parameters being met and movement of a finger or stylus upon the screen.

FIG. 3A illustrates the different modes and how they fit together and overlap. The left side of FIG. 3A illustrates the “normal” screen mode or starting point in which no screen adjustments are present. When a first set of parameters is met, the “shift” screen mode is initiated. At this point, the screen temporarily deforms to indicate a change in state. When a second set of parameters is met, the “adjust” screen mode is initiated. During the “adjust” screen mode, the screen is moved in a direction according to movement of the finger or stylus upon the screen. When the second set of parameters is no longer met, the “adjust” screen mode ends, but the screen is still under a “shift” screen mode. This mode allows the user to work from the screen in its adjusted position. When the first set of parameters is no longer met, the “shift” screen mode ends, and the screen returns to a “normal” mode.

FIG. 3B is a detailed flowchart for a screen image shifting process, which is implemented by a processor of the controller 110. In step S11, it is determined whether the touch panel 130 received a touch by a finger, thumb, stylus, or other object intended to activate an application of the electronic device 100. When the controller 110 determines that no touch is detected, the controller 110 waits until it detects a touch. When the controller 110 determines that the touch panel 130 received a touch, it is determined in step S11.5 if a shifted screen image exists. If a screen image exists, the process moves to step S12. If a shifted screen image does not exist, such as coming from a normal mode, the process moves to step S13.

In step S12, it is determined whether the area of the touch was outside a shifted screen image. If the received touch is outside the shifted screen image, the process moves to step S21, where the “shift” screen mode is terminated and the controller 110 shifts the shifted screen image back to a “normal” screen mode (a state of no-shifted position). If the area of the received touch is not outside the shifted screen image, the process moves to step S13.

In step S13, the controller 110 determines whether the area that was touched on the touch panel 130 exceeds a continued threshold value. When the size of the touched area exceeds a pre-determined threshold value, a1 or the time in which the continued touch exceeds a pre-determined threshold value, t1, or the pressure of the touch exceeds a pre-determined threshold value, p1 (at least one or more of the three), the controller 110 moves to the next step, S14. A1, t1, and p1 make up a first set of parameters. The value of a1 or p1 is a threshold value in which the touch panel 130 was touched strongly by the finger or stylus. An example of a threshold value, t1 is 0.5 to 1.0 seconds. However, other threshold values can be implemented. If any of a1 or t1 or p1 does not meet the pre-determined threshold value in step S13, the process returns to step S11 and awaits another touch to the touch panel 130. Stated another way, any one of the first set of parameters needs to meet certain threshold values before a “shift” screen mode is initiated. The surface area and the time of touch are large enough to exceed simply scrolling through a list of displayed items, which are typically initiated with a quick tip of the finger or tip of the thumb. In addition, a large or heavy thumb print area would shift the image a larger distance than a small or lighter thumb print area, as will be described later with reference to FIGS. 9A-9B. Moreover, normal touch operations like scrolling or clicking etc. are processed on the shifted screen image so that the user can operate the device normally on the shifted screen image.

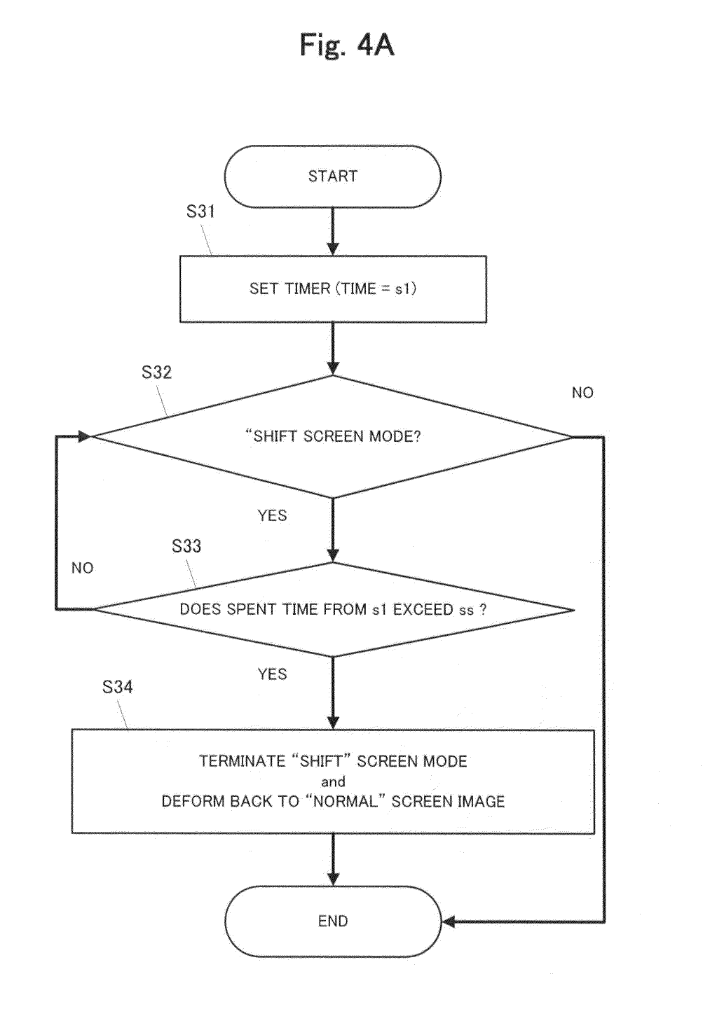

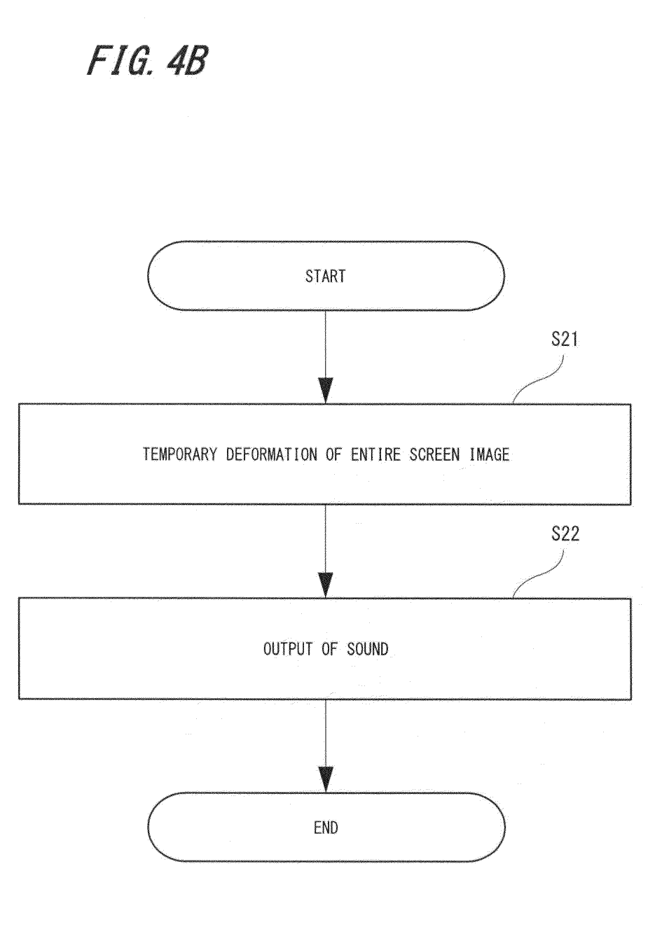

In step S14, if the present screen state is not in the “shift” screen mode, the process moves to the next step, S15, where the controller 110 initiates the “shift” screen mode. The “shift” screen mode will now be described with reference to the flowchart of FIG. 4A. In step S31, the controller 110 sets a timer for termination of the “shift” screen mode, where the initial time is set to s1. In step S32, if the screen state is not set in the “shift” screen mode, the process ends. If the screen state is in the “shift” screen mode, the process moves to step S33. In step S33, if a total time in the “shift” screen mode exceeds a pre-determined threshold value, ss, the controller 110 moves to the next step S34. In step S34, the “shift” screen mode is terminated and the controller 110 shifts the shifted screen image back to “normal” screen mode (a state of no-shifted position). If the spent total time in the “shift” screen mode doesn't exceed the value of ss, the process moves back to step S32.

If the present screen state in step S14 of FIG. 3B is in the “shift” screen mode (and also after step S15), the process moves to step S16. In step S16, the controller 110 initiates the “adjust” screen mode of the display 120. FIG. 4B illustrates the point of entering the “adjust” screen mode from step S16. In step S21, the controller 110 temporarily deforms the entire displayed image on the display 120. In step S22, the speaker 104 outputs a notification sound to indicate to the user that the “adjust” screen mode has been entered. Embodiments include other notifications, such as a visual indication or a vibration of the electronic device 100, or any combination of audio, visual, and vibrating notifications.

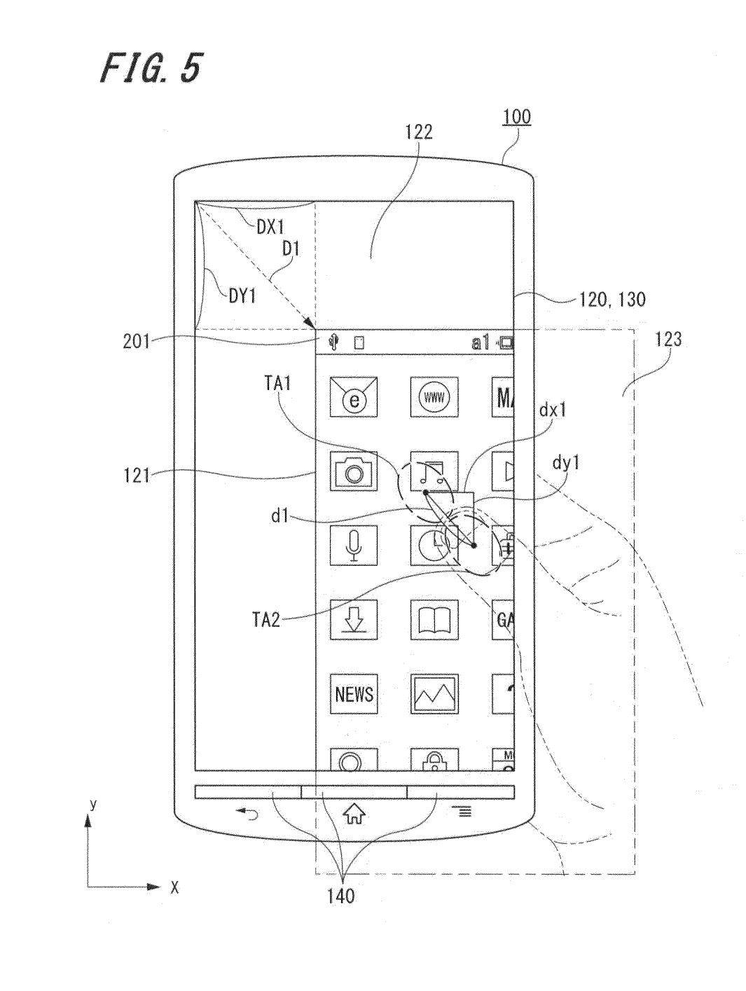

Step S17 of FIG. 3B determines whether the touch to the touch panel 130 meets or exceeds another pre-determined threshold value, t2 for a second set of parameters. If the time of the received touch does not meet or exceed t2, the process moves to step S22, where the “adjust” screen mode is terminated. The “shift” screen mode is still active in step S22. If the time of the received touch does meet or exceed t2, the process moves to step S18. In step S18, the touch panel 130 detects the moving direction of a finger or stylus that touched the touch panel 130, and the controller 110 calculates the movement distance of the finger or stylus in the moving direction. In step S19, the controller 110 calculates the distance the screen image should be shifted, relative to the distance the finger or stylus moved. The calculation will be described in more detail below with reference to FIG. 5. In step S20, the controller 110 shifts the screen image the calculated distance from step S19. The moving direction is relative to the moving direction of the finger or stylus.

After shifting the screen image, the controller 110 returns to step S17, where the pre-determined threshold value, t2 is measured again. When the touch to the touch panel 130 is less than or equal to t2, the process proceeds to step S22, where the “adjust” screen mode is terminated. At this point, the user can manipulate the touch panel 130 in the adjusted position. With the “shift” screen mode still active in step S22, the process moves back to step S11, where the process begins again. The touch panel 130 will stay in the adjusted position from step S20 until there is a touch outside the shifted screen image (step S12), at which point, the “shift” screen mode is terminated and the screen image returns to the “normal” screen mode in step S21. Other parameters can also terminate the “shift” screen mode in step S21, such as a timer or clicking a button, or a tapping gesture. The bottom portion of FIG. 3A illustrates some of the steps in FIG. 3B with respect to the “shift” and “adjust” screen modes.

With reference back to FIG. 2, a user is shown holding the electronic device 100 in the right hand. A status bar 201 is arranged at the upper portion of the screen image. The status bar 201 displays the states of things, such as a battery remaining charge or a wireless communication state. The status bar 201 also displays the present time. Area TA1 is shown as a broken line in FIG. 2. Area TA1 corresponds to the area of the touch penal 130 that detected a touch from the right thumb F. The controller 110 transfers to the “shift” screen mode when the size of the area TA1 exceeds the threshold value a1 and when the continuation time of the touch exceeds the threshold value t1. Therefore, the electronic device 100 transfers to the “adjust” screen mode when a user's touch to the screen with the right thumb F is a comparatively large thumb print area and the touch state continues for a certain period of time (t1). When the electronic device 100 transfers to the “adjust” screen mode, the electronic device 100 implements the notification process described above.

Upon transferring to the “adjust” screen mode, the user performs the shifting operation by drawing or pulling the arbitrary parts of the screen image towards the vicinity of the thumb F. With reference to FIG. 2, the user would reach towards the upper left portion of the screen and pull the screen towards the bottom of the thumb F, i.e. pull the screen downward towards the bottom right area of the electronic device 100, as shown by the arrow M1.

After the displacement of the screen in the direction of the arrow M1, a displaced screen image 121 illustrated in FIG. 5 results. The horizontal direction of the screen image displacement is defined in an x direction as DX1, and the vertical direction of the screen image displacement is defined in a y direction as DY1. An area 122 does not display an image as a result of the displacement of the screen image 121. In an embodiment, the area 122 could display as a different color, such as a colored background. The area 123 of the original screen image is no longer displayed on the display 120 of the electronic device 100, but instead protrudes from the display 120.

When a touch position changes from area TA1 to area TA2, it sets a distance, d1 which connects the substantially center of the two areas TA1 and TA2. The distance D1 in which the screen image 121 shifts is a value obtained by multiplying the predetermined coefficient (alpha) by the distance d1. Stated another way, the controller 110 multiplies the alpha coefficient by the distance dx1 of the x direction displacement of the thumb F to obtain DX1. Likewise, the controller 110 multiples the alpha coefficient by the distance dy1 of the y direction displacement of the thumb F to obtain DY1. When the alpha coefficient is equal to one, the movement distance of the thumb F, d1 is equal to the screen image 121 displacement of D1. D1 will usually be larger than d1, since an object of the description herein is to quickly bring the entire display 120 within reach of the thumb F. The user can now touch-operate every part of the display 120 with just the thumb F.

FIG. 5 illustrates just one direction in which the screen image 121 can be displaced. Embodiments include any direction, according to the user's finger or stylus moving direction. As an example, the bottom lower portion of the electronic device 100 can be held in the left hand and operated with the left thumb. Movement of the left thumb downward towards the lower left area of the electronic device 100 will displace the display 120 towards the bottom left area. A protruding portion of the display 120 will result along the left side of the electronic device 100, similar to area 123. An empty area along the top left side, similar to area 122 will also result. When the “adjust” screen mode is finished, the display 120 is still shifted. When the “shift” screen mode is finished, the display 120 will return to the “normal” screen mode, such as the image illustrated in FIG. 2.

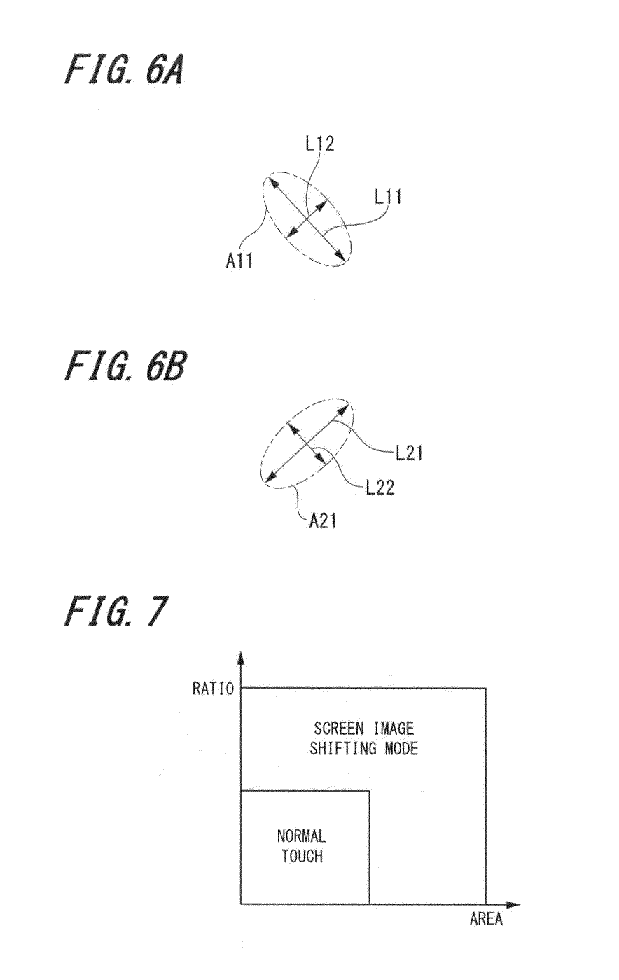

Determining whether to enter the “adjust” screen mode (and accordingly the “shift” screen mode) previously described in FIG. 3 was contingent upon the area of a received touch and the length of time of the touch. FIG. 6A illustrates an area A11 that a right thumb might occupy when it touches the display 120. FIG. 6B illustrates an area A21 that a left thumb might occupy when it touches the display 120. For a right hand or a left hand, the direction of a long axis of the thumb areas are reversed, where L11 is the right-handed long axis and L21 is the left-handed long axis. The controller 110 determines whether to initiate an “adjust” screen mode, based upon movement of the area of the thumb. Stated another way, the controller 110 determines whether the long axis of the thumb touching the display 120 is in a substantially parallel direction or in a substantially orthogonal direction to the long axis of the touch area.

With reference to FIG. 6A, when movement of the touched area is in a direction substantially parallel to the long axis L11 of the touch area A11, the controller switches into an “adjust” screen mode for a right-handed thumb. When movement of the touched area is in a direction substantially orthogonal to the long axis L11 of the touch area A11, the controller stays in the “normal” screen mode. With reference to FIG. 6B, when movement of the touched area is in a direction substantially parallel to the long axis L21 of the touch area A21, the controller switches into an “adjust” screen mode for a left-handed thumb. When movement of the touched area is in a direction substantially orthogonal to the long axis L21 of the touch area A21, the controller stays in the “normal” screen mode. By using the movement distinctions described herein, the controller 110 can determine whether to move the screen image 121 to the left or to the right. In addition to determining the direction of the long axis, the threshold values previously described allow the controller 110 to determine whether to enter into an “adjust” screen mode, or if the received motion is simply a downward scrolling motion.

FIG. 7 is a graph showing a relationship between an area of touch (x axis), and a ratio of the long axis to the short axis of the touch area (y axis). For FIG. 6A, the ratio would be L11/L12, and for FIG. 6B, the ratio would be L21/L22. FIG. 7 illustrates an area of normal touch in the lower left region of the graph. When the area of touch exceeds a first threshold value or the ratio of long axis to short axis exceeds a second threshold value, the “adjust” screen mode is initiated.

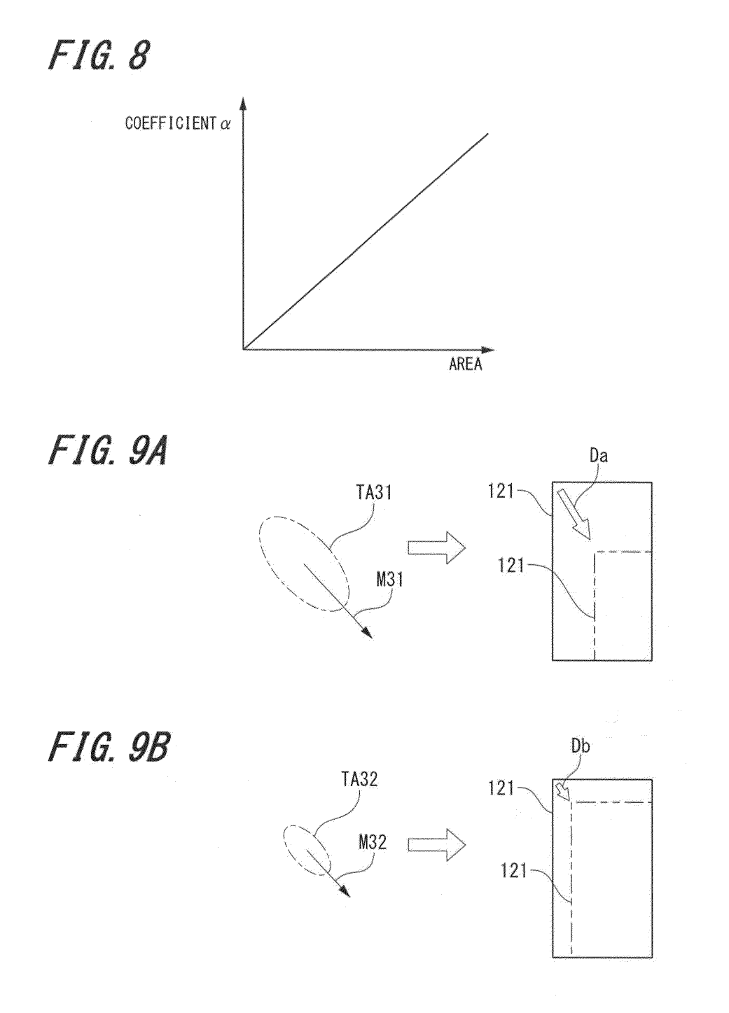

FIG. 8 is a graph showing a relationship between the area of touch (x axis) and the alpha coefficient (y axis). The alpha coefficient is used to establish a relationship between the distance the thumb traverses and the distance the screen display should be displaced when the “adjust” screen mode is initiated.

FIG. 9A illustrates an area of touch TA31 and a length of movement M31 when the thumb pulls the screen towards the lower right portion of the electronic device 100, after initiating the “adjust” screen mode. FIG. 9B illustrates a smaller area of touch TA32 and a length of movement M32 when the thumb pulls the screen towards the lower right portion of the electronic device 100, after initiating the “adjust” screen mode. The alpha coefficient changes, depending upon the area of touch. With reference back to FIG. 8, a larger area of touch, such as TA31 corresponds to a larger alpha coefficient. Likewise, a smaller area of touch, such as TA32 corresponds to a smaller alpha coefficient. Therefore, the larger touch area TA31 results in a larger screen displacement, Da illustrated in FIG. 9A. Similarly, the smaller touch area TA32 results in a smaller screen displacement, Db illustrated in FIG. 9B.

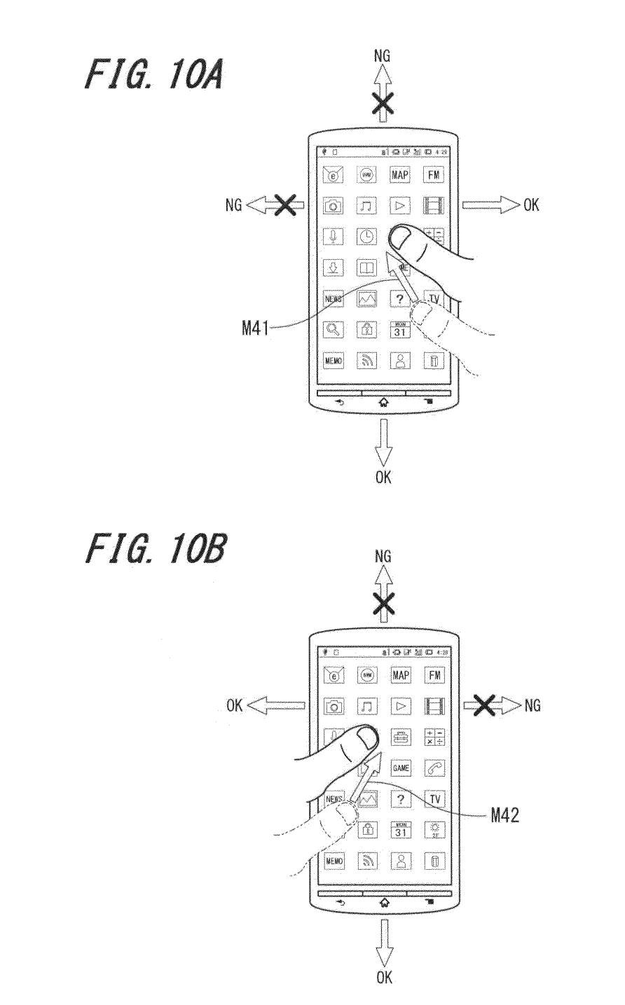

FIG. 10A is an illustration that shows a moving direction of a screen image 121 in response to a touch of a right thumb. From previous calculations for a long axis of the touch area versus a short axis of the touch area (refer to FIG. 6A), the controller 110 permits a shift of the screen image 121 down and to the right when the “adjust” screen mode has been initiated. However, a movement by the right thumb upwards and/or to the left does not permit a shift of the screen image 121 in the M41 direction illustrated in FIG. 10A. A movement such as M41 does not match the associated thumb area axes, and therefore a similar shift of the screen image 121 is prohibited. A movement such as M41 for a right thumb would be interpreted as having a different user purpose, such as scrolling the screen upwards. However, when movement is made by a user in a downwardly right direction, the screen image 121 will automatically shift back in the M41 direction to return to the original screen image 121 when a normal screen mode is resumed.

FIG. 10B is an illustration that shows a moving direction of a screen image 121 in response to a touch of a left thumb. From previous calculations for a long axis of the touch area versus a short axis of the touch area (refer to FIG. 6B), the controller 110 permits a shift of the screen image 121 down and to the left when the “adjust” screen mode has been initiated. However, a movement by the left thumb upwards and/or to the right does not permit a shift of the screen image 121 in the M42 direction illustrated in FIG. 10B. A movement such as M42 does not match the associated thumb area axes, and therefore a similar shift of the screen image 121 is prohibited. A movement such as M42 for a left thumb would be interpreted as having a different user purpose, such as scrolling the screen upwards. However, when movement is made by a user in a downwardly left direction, the screen image 121 will automatically shift back in the M42 direction to return to the original screen image 121 when a normal screen mode is resumed.

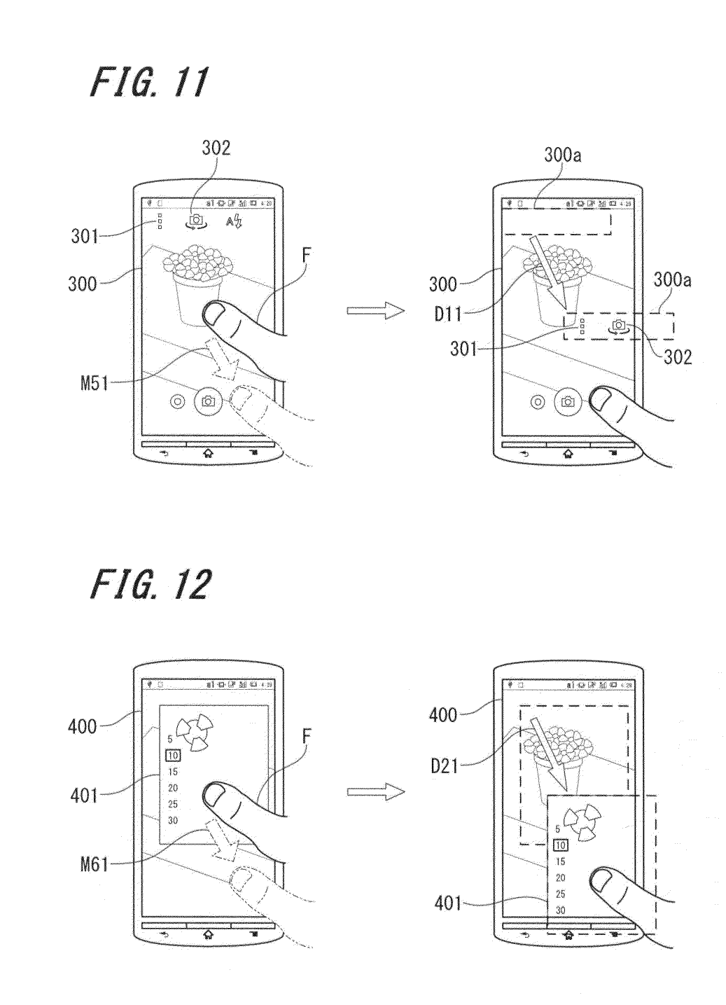

Embodiments described herein also provide that only certain icons of a specific layer in the screen image 300 are shifted during an “adjust” screen mode. FIG. 11 illustrates two icons 301 and 302 in the upper portion of the screen image 300. When a right thumb F moves towards the bottom right in the M51 direction, the controller 110 only shifts the upper icons 301 and 302 and leaves the remaining icons unmoved. This results in the display 300a in which the icons 301 and 302 have been shifted from an upper left position to a lower right position, illustrated by a D11 arrow. As a specific example, given for illustrative purposes only, the electronic device 100 displays the image of a camera since the camera mode has been initiated. Therefore, during a “shift” or “adjust” screen mode, only the camera-associated icons are shifted. Embodiments described herein also provide for other application-specific layers to be shifted during a “shift” or “adjust” screen mode, including but not limited to a mail-related icon layer, a social media-related icon layer, a news-related icon layer, a music-related icon layer, a sports-related icon layer, a weather-related icon layer, and a photo-related icon layer, as well as several other icon layers.

FIG. 12 illustrates an embodiment in which only a pop-up window 401 in the screen image 400 is shifted during a “shift” or “adjust” screen mode by a right thumb F in a direction of M61. FIG. 12 further illustrates that the pop-up window 401 has been moved by the thumb F towards the bottom right position, illustrated by a D21 arrow. The controller 110 has moved only the pop-up window 401 and left the remaining icons unmoved. This embodiment provides an advantage of responding or interacting with a pop-up window, then moving it aside when finished.

Embodiments described herein have been primarily illustrated for a small wireless device, such as a smartphone. However, a larger-sized wireless device, such as a tablet, or any wireless device with a touch screen can also be used with embodiments described herein.

An embodiment for use with a tablet, which is given for illustrative purposes only, could execute a “shift” or “adjust” screen mode by a repeated movement of the thumb. With reference to FIG. 5, the displaced screen 123 of a tablet may require multiple movements of the thumb in order to reach the desired icons in an upper left portion of the original screen display 121.

Numerous modifications and variations of the present invention are possible in light of the above teachings. The embodiments described with reference to FIGS. 6-12 may be practiced individually or in any combination thereof. It is therefore to be understood that within the scope of the appended claims, the invention may be practiced otherwise than as specifically described herein.

The functions, processes, and algorithms described herein may be performed in hardware or software executed by hardware, including computer processors and/or programmable processing circuits configured to execute program code and/or computer instructions to execute the functions, processes, and algorithms described herein. A processing circuit includes a programmed processor, as a processor includes circuitry. A processing circuit also includes devices such as an application specific integrated circuit (ASIC) and conventional circuit components arranged to perform the recited functions.

The functions and features described herein may also be executed by various distributed components of a system. For example, one or more processors may execute these system functions, wherein the processors are distributed across multiple components communicating in a network. The distributed components may include one or more client and/or server machines, in addition to various human interface and/or communication devices (e.g., display monitors, smart phones, tablets, personal digital assistants (PDAs)). The network may be a private network, such as a LAN or WAN, or may be a public network, such as the Internet. Input to the system may be received via direct user input and/or received remotely either in real-time or as a batch process. Additionally, some implementations may be performed on modules or hardware not identical to those described. Accordingly, other implementations are within the scope that may be claimed.

It must be noted that, as used in the specification and the appended claims, the singular forms “a,” “an,” and “the” include plural referents unless the context clearly dictates otherwise.

The above disclosure also encompasses the embodiments noted below.

(1) An electronic device comprising: a display configured to display a graphical user interface (GUI) for a user to control aspects of the electronic device; a touch panel superimposed on or integrated with the display; and circuitry configured to initiate a process to shift the GUI on the display upon determining that an area of a touch input exceeds a predetermined area or a continuous duration of the touch input exceeds a predetermined period of time or an applied pressure of the touch input exceeds a predetermined pressure during movement of the area of the touch input.

(2) The electronic device according to (1), wherein the movement of the area of the touch input comprises movement of a finger or a thumb of a hand grasping the electronic device towards a palm of the hand.

(3) The electronic device according to (1) or (2), wherein the movement of the area of the touch input has a horizontal component and a vertical component.

(4) The electronic device according to any one of (1) to (3), wherein the shifted GUI returns to an original position within the display when the predetermined area of the touch input is removed from the touch panel.

(5) The electronic device according to any one of (1) to (4), wherein the GUI on the display is shifted towards a lower right area of the electronic device for a grasping right hand, and is shifted towards a lower left area of the electronic device for a grasping left hand.

(6) The electronic device according to any one of (1) to (5), wherein the circuitry is configured to determine whether the touch input comprises a touch from a left-handed or a right-handed finger or a thumb.

(7) The electronic device according to any one of (1) to (6), wherein the right-handed finger or thumb initiates shifting of the GUI when the area of the touch input is moved towards a lower right area of the electronic device, and shifting of the GUI is not initiated when the area of the touch input is moved towards an upper left area of the electronic device.

(8) The electronic device according to any one of (1) to (7), wherein the left-handed finger or thumb initiates shifting of the GUI when the area of the touch input is moved towards a lower left area of the electronic device, and shifting of the GUI is not initiated when the area of the touch input is moved towards an upper right area of the electronic device.

(9) The electronic device according to any one of (1) to (8), wherein a predetermined value of a ratio of a longitudinal axis versus a transversal axis of the area of the touch input initiates the GUI of the display to shift a proportional distance.

(10) The electronic device according to any one of (1) to (9), wherein the proportional distance of the shifted GUI is equal to a distance of the movement of the area of the touch input multiplied by a coefficient.

(11) The electronic device according to any one of (1) to (10), wherein a value of the coefficient is proportional to the area of the touch input.

(12) The electronic device according to any one of (1) to (11), wherein a moving direction of the shifted GUI is equal to a moving direction of the area of the touch input.

(13) The electronic device according to any one of (1) to (12), wherein the GUI comprises more than one specific layer of icons.

(14) The electronic device according to any one of (1) to (13), wherein only one specific layer of icons is shifted, and icons from other specific layers are not shifted.

(15) The electronic device according to any one of (1) to (14), wherein each of the specific layers of icons comprise similar content-related icons.

(16) The electronic device according to any one of (1) to (15), wherein at least one of the specific layers of icons comprises a pop-up window.

(17) The electronic device according to any one of (1) to (16), wherein the electronic device comprises a wireless smartphone.

(18) The electronic device according to any one of (1) to (17), wherein the electronic device comprises a wireless tablet.

(19) A method of shifting a graphical user interface (GUI) of an electronic device having a touch panel superimposed on or integrated with a display, the method comprising: setting a screen shift mode of the electronic device when a touch exceeds a predetermined area of touch or a predetermined pressure of touch or a continuous duration of time has been detected upon movement of the touch panel of the electronic device, and shifting at least a portion of the GUI in proportion to the movement of the touch panel upon setting the screen shift mode, via a processor of the electronic device.

(20) A non-transitory computer readable medium having instructions stored thereon that when executed by one or more processors cause an electronic device to perform a method comprising: setting a screen shift mode of the electronic device when a touch exceeds a predetermined area of touch or a predetermined pressure of touch or a continuous duration of time has been detected upon movement of a touch panel of the electronic device, and shifting at least a portion of a graphical user interface of the electronic device in proportion to the movement of the touch panel upon setting the screen shift mode, via a processor of the electronic device.

1. An electronic device, comprising:
a display configured to display a graphical user interface (GUI) for a user to control aspects of the electronic device;
a touch panel superimposed on or integrated with the display; and
circuitry configured to
initiate a process to shift the GUI on the display upon determining that an area of a touch input exceeds a predetermined area or a continuous duration of the touch input exceeds a predetermined period of time or an applied pressure of the touch input exceeds a predetermined pressure during movement of the area of the touch input.

2. The electronic device of claim 1, wherein the movement of the area of the touch input comprises movement of a finger or a thumb of a hand grasping the electronic device towards a palm of the hand.

3. The electronic device of claim 2, wherein the movement of the area of the touch input has a horizontal component and a vertical component.

4. The electronic device of claim 3, wherein the shifted GUI returns to an original position within the display when the predetermined area value of the touch input is removed from the touch panel.

5. The electronic device of claim 1, wherein the GUI on the display is shifted towards a lower right area of the electronic device for a grasping right hand, and is shifted towards a lower left area of the electronic device for a grasping left hand.

6. The electronic device of claim 5, wherein the circuitry is configured to determine whether the touch input comprises a touch from a left-handed or a right-handed finger or thumb.

7. The electronic device of claim 6, wherein the right-handed finger or thumb initiates shifting of the GUI when the area of the touch input is moved towards a lower right area of the electronic device, and shifting of the GUI is not initiated when the area of the touch input is moved towards an upper left area of the electronic device.

8. The electronic device of claim 6, wherein the left-handed finger or thumb initiates shifting of the GUI when the area of the touch input is moved towards a lower left area of the electronic device, and shifting of the GUI is not initiated when the area of the touch input is moved towards an upper right area of the electronic device.

9. The electronic device of claim 1, wherein a predetermined value of a ratio of a longitudinal axis versus a transversal axis of the area of the touch input initiates the GUI of the display to shift a proportional distance.

10. The electronic device of claim 9, wherein the proportional distance of the shifted GUI is equal to a distance of the movement of the area of the touch input multiplied by a coefficient.

11. The electronic device of claim 10, wherein a value of the coefficient is proportional to the area of the touch input.

12. The electronic device of claim 10, wherein a moving direction of the shifted GUI is equal to a moving direction of the area of the touch input.

13. The electronic device of claim 1, wherein the GUI comprises more than one specific layer of icons.

14. The electronic device of claim 13, wherein only one specific layer of icons is shifted, and icons from other specific layers are not shifted.

15. The electronic device of claim 13, wherein each of the specific layers of icons comprise similar content-related icons.

16. The electronic device of claim 13, wherein at least one of the specific layers of icons comprises a pop-up window.

17. The electronic device of claim 1, wherein the electronic device comprises a wireless smartphone.

18. The electronic device of claim 1, wherein the electronic device comprises a wireless tablet.

19. A method of shifting a graphical user interface (GUI) of an electronic device having a touch panel superimposed on or integrated with a display, the method comprising:
setting a screen shift mode of the electronic device when a touch exceeds a predetermined area of touch or a predetermined pressure of touch or a continuous duration of time has been detected upon movement of the touch panel of the electronic device; and
shifting at least a portion of the GUI in proportion to the movement of the touch panel upon setting the screen shift mode, via a processor of the electronic device.

20. A non-transitory computer readable medium having instructions stored thereon that when executed by one or more processors cause an electronic device to perform a method comprising:
setting a screen shift mode of the electronic device when a touch exceeds a predetermined area of touch or a predetermined pressure of touch or a continuous duration of time has been detected upon movement of a touch panel of the electronic device; and
shifting at least a portion of a graphical user interface of the electronic device in proportion to the movement of the touch panel upon setting the screen shift mode, via a processor of the electronic device.
